(19) United States
(12) Patent Application Publication
(10) Pub. No.: US 2005/0136383 A1
(43) Pub. Date: Jun. 23, 2005

(54) Pluggable sequencing engine

(75) Inventors: Thomas J. Dinger, Sunnyvale, CA (US); Jonathan T. Zempel, Campbell, CA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/738,829

(22) Filed: Dec. 17, 2003

(51) Int. Cl. G09B 19/00

(52) U.S. Cl. 434/236

(57) ABSTRACT

The present invention is a method, system and apparatus for pluggable simple sequencing. A simple sequencing system which has been configured for pluggability in accordance with the present invention can include logic implementing a sequencing behavioral model disposed within a simple sequencing engine. A sequencing loop can be programmed in the simple sequencing engine for mapping desired behavioral operations to individual behavioral operations in the behavioral model. Finally, an ace to the simple sequencing engine can be provided for receiving data corresponding to a sequencing informational model defined externally to the simple sequencing engine. Preferably, the interface further can include a configuration for receiving sequencing context information for processing by the individual behavioral operations.

### BACKGROUND OF THE INVENTION

1. Statement of the Technical Field

The present invention relates to the field of learning object management, and more particularly to sequencing in a learning technology system (LTS).

2. Description of the Related Art

Learning technology systems provide for the total management of an on-line learning experience--from content creation to course delivery. In the prototypical LTS, one or more course offerings can be distributed about a computer communications network for delivery to students enrolled in one or more corresponding courses. The course offerings can include content which ranges from mere text-based instructional materials to full-blown interactive, live classroom settings hosted entirely through the computer communications network. So advanced to date has the ability of the LTS to deliver content become, that nearly any learning experience formerly delivered through in-person instruction now can be delivered entirely on-line and even globally over the Internet.

The conventional LTS can include a learning management server (LMS) configured to manage the introduction and distribution of course materials to enrolled students. The LMS further can be configured to import course content created both by coupled authoring tools and third party authoring tools which can package course content according to any one of the well known course content packaging standards, such as the ADL Shareable Content Object Reference Model (SCORM) and the Airline Industry Computer Based Training Committee (AICC). Once imported, online course instances can be created based upon a course master reflecting the packaged course content. The on-line course instances can be cataloged for public availability to registered students and the content reflected within the on-line course instances can be distributed to the students on-demand.

IMS Simple Sequencing, which is the specification adopted by the learning objects community in ADL SCORM version 1.3, provides a learner with a sequence of learning activities to guide them through a learning space in order to achieve a specific learning objective. IMS Simple Sequencing is based on instructional design strategies selected by the instructor of a course and can be expressed in a markup language document referred to as the “manifest file”. The LTS can maintain a simple user model based both upon the learning objects which the student has visited and also upon intermediate test results. Using this information, the LTS can decide what learning object should be presented next in the sequence.

In IMS Simple Sequencing, learning activities are managed and arranged in the form of an activity tree in which each node can represent a learning activity. The root of the tree can be the main activity, while the branches can represent the sub-activities. Navigation through the activity space can be based upon a pre-order traversal method. The sequencing rules can decide whether a particular node will be traversed or skipped in the learning process based upon the status or values obtained from the tracking and activity state models of the simple sequencing logic.

The document, IMS Simple Sequencing Specification, Version 1.0 Public Draft Specification (Oct. 17, 2002)(IMS SSS) defines IMS Simple Sequencing and, in particular, specifies a method for representing the intended behavior of an authored learning experience such that any LTS can sequence discrete learning activities in a consistent way. In accordance with the IMS SSS, a learning designer or content developer can declare the relative order in which elements of content are to be presented to the learner and the conditions under which a piece of content is selected and delivered or skipped during presentation.

The IMS SSS also defines the required behaviors and functionality that conforming systems must implement. The IMS SSS further incorporates rules that describe the branching or flow of learning activities through content according to the outcomes of a learner's interactions with content. Notably, this representation of intended instructional flow may be created manually or with authoring systems, that produce output that conforms to the IMS SSS. The representation of sequencing further may be interchanged between systems designed to deliver instructional activities to learners. In any case, the components of an LTS used to execute the specified rules and behaviors, when content is delivered to a learner, generally are referred to as a ‘sequencing engine’.

Presently, a small number of LTS vendors have implemented simple sequencing engines according to the IMS SSS. Whereas the International Business Machines Corporation of Armonk, New York first implemented IMS compliant simple sequencing in the Lotus Learning Management System version 1.0, other vendors similarly have incorporated simple sequencing within the logic of the LTS. In this regard, conventional simple sequencing has been included as part and parcel of the LTS to which the simple sequencing logic can be inextricably bound.

In more particular illustration, the prototypical integration of IMS SS in an LTS includes a sequencing engine implementing both a sequencing information model and a sequencing behavior model. As is well-known in the art, the information model can provide instructions useful in determining which activity ought to be next presented to the learner. In contrast, the sequencing behavior model can provide the logic for processing the instructions of the information model to determine which activity ought to be next presented to the learner.

In any case, both the information model and the behavior model are included as part of the same sequencing engine and are inextricably bound to one another. Yes, while incorporating both the behavior and information models in a tight coupling within a sequencing engine can suffice for the directed application of simple sequencing to the content managed within the LTS, it would be preferable to decouple simple sequencing logic so that the simple sequencing logic could be deployed in the context of another content management system, whether an LTS, non-LTS, or otherwise. In this regard, so long as a tight coupling remains between the information model and the behavior model, no such pluggable application of simple sequencing behaviors will be possible.

### SUMMARY OF THE INVENTION

The present invention addresses the deficiencies of the art in respect to simple sequencing in an LTS and provides a novel and non-obvious method, system and apparatus for pluggable simple sequencing. A simple sequencing system which has been configured for pluggability in accordance with the present invention can include logic implementing a sequencing behavioral model disposed within a simple sequencing engine. A sequencing loop can be programmed in the simple sequencing engine for mapping desired behavioral operations to individual behavioral operations in the behavioral model. Finally, an interface to the simple sequencing engine can be provided for receiving data corresponding to a sequencing informational model defined externally to the simple sequencing engine. Preferably, the interface further can include a configuration for receiving sequencing context information for processing by the individual behavioral operations.

In accordance with the present invention, a pluggable simple sequencing engine can include one or more behavioral operations implementing a sequencing behavioral model. A mapping of the behavioral operations to navigation requests further can be provided in the pluggable simple sequencing engine. Finally, an interface can be provided both for receiving in the simple sequencing engine data implementing a sequencing informational model which has been defined externally to the simple sequencing engine, and also for returning to an external calling object sequencing information produced by processing the data in the behavioral operations.

Notably, the behavioral operations can include at least one navigation operation selected from the group consisting of start, resume, continue, previous, choose and exit. The interface further can include a parameter conduit through which specific sequencing context which has been defined externally to the simple sequencing engine can be received. In this regard, the specific sequencing context can include, for example, an activity, attempt, global state, limit conditions, objective, progress and rollup context.

In a simple sequencing engine, a simple sequencing method can include receiving in the engine data implementing an informational model defined in a coupled content delivery application and a navigation request encapsulating a desired behavioral operation. The desired behavioral operation and the data can be extracted from the navigation request and the desired behavioral operation can be mapped to a method call in the engine. The data can be passed to the method call programmed to produce a result which can be returned to the coupled content delivery application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an LTS configured with a pluggable sequencing engine in accordance with the present invention; and,

FIG. 2 is a flow chart illustrating a process for handling a simple sequencing ion request in the pluggable simple sequencing engine of FIG. 1.

### DETAILED DESCRIPTION OF THE PREFERRED EMBODIMENTS

The present invention is system, method and apparatus for pluggable simple sequencing. In accordance with the present invention, a simple sequencing engine can be configured to process simple sequencing operations through the processing of a simple sequencing information model disposed within a navigation request. In this regard, while the behavior model for simple sequencing can be included as part of the simple sequencing engine, the simple sequencing information model can remain separate from the behavior model and can be associated with a navigation request. Accordingly, the simple sequencing engine can be pluggably integrated in any content delivery system requiring simple sequencing behavior, regardless of the information model.

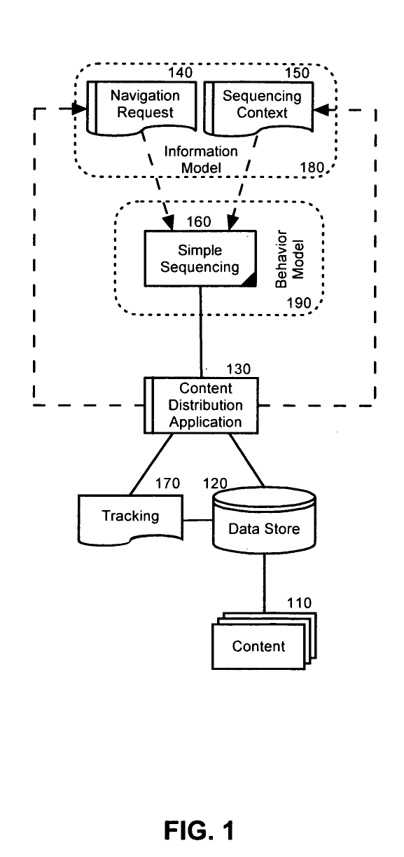

In further illustration of the inventive aspects of the foregoing invention, FIG. 1 is a schematic illustration of an LTS configured with a simple sequencing engine in accordance with the present invention. The system can include a simple sequencing engine 160 coupled to a content distribution application 130. The content distribution application 130 can be coupled to a data store 120 of content 110. The content distribution application 130 further can be configured to distribute selected assets in the content 110 to requesting content consumers (not shown) according to a logical ordering of distribution known in the art as a “sequence”. Thus, the content distribution application 130 can be an LTS, or any other application type in which content can be distributed to end users according to a logical ordering of the content.

The content distribution application 130 can be coupled to tracking data 170 for the distribution of the content 110 to the content consumers. The tracking data 170 can record the results of interactions with the content 110 which can be used subsequently to select additional content 110 to be distributed to the content consumers. In this regard, when navigation of the arrangement of the content 110 will be required in the content distribution application 130, the tracking data 170 can be associated with a navigation request 140 and can be provided to the simple sequencing engine 160 as a parameter to a request for a navigation operation in the sequencing loop of the simple sequencing engine 160.

Specifically, the sequencing process of the simple sequencing engine 160 can be initiated through a call to a handler exposed by the simple sequencing engine 160. The desired sequencing navigation operation along with the current state information can be encapsulated within the navigation request 140 passed to the simple sequencing engine 160 as a parameter to the call to the handler. The navigation operation can include, for example, a “start”, “resume”, “continue”, “previous”, “choose” or “exit” operation. Notably, sequencing context 150 further can be provided to the simple sequencing engine 160 as a parameter to the call and can include application specific logic, such as “Activity”, “Attempt”, “GlobalState”, “LimitConditions”, “Objective”, “Progress” and “RollupContext”.

The skilled artisan will recognize through the illustration of FIG. 1 that the architecture of the system of the invention essentially separates the sequencing information model 180 from the sequencing behavior model 190. In this respect, the system illustrated in FIG. 1 differs dramatically from the known architecture of pilot implementations of simple sequencing. By separating the models 180, 190, however, several advantages can arise. Most importantly, the simple sequencing engine 160 can be rendered pluggable and thus portable as the application specific elements of simple sequencing can be provided by the content distribution application 130 and not by the simple sequencing engine 160. Moreover, the implementation of the behavioral aspects of the simple sequencing engine 160 can change freely without impacting the core sequencing logic of the content distribution application 130. Finally, in consequence of the bifurcation of the models 180, 190, multiple simple sequencing engine behaviors can be supported within a single content distribution application 130.

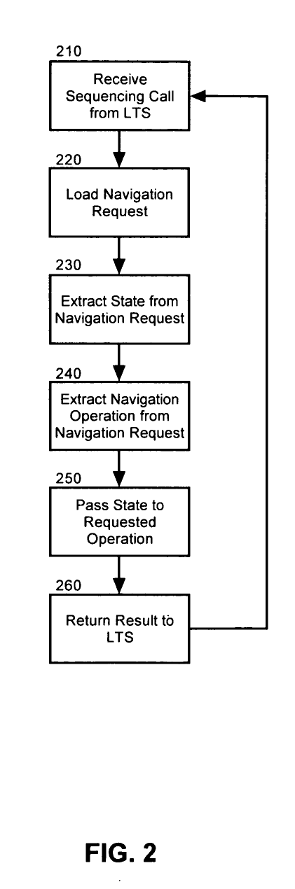

In more complete illustration of the process performed within the simple sequencing engine 160 of FIG. 1, FIG. 2 is a flow chart illustrating a process for handling a simple sequencing operation request in the context of an LTS. Beginning in block 210, a sequencing call for a navigation request can be received in the LTS. In block 220, the navigation request can be loaded for analysis and in block 230, the contextual state of the LTS can be extracted from the navigation request. Similarly, in block 240, the desired navigation operation can be extracted from the navigation request.

In block 250, the contextual state can be passed to a behavior mapped to the extracted desired operation. In this regard, the contextual state can be passed as a parameter to a method call in the simple sequencing engine which has been associated with the extracted desired operation. The method implicated by the extracted desired operation can execute its respective logic thereby producing a result. In block 260, the result can be returned to the calling object in the LTS.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A simple sequencing system comprising:
logic implementing a sequencing behavioral model disposed within a simple sequencing engine;
a sequencing loop programmed in said simple sequencing engine mapping desired behavioral operations to individual behavioral operations in said behavioral model; and,
an interface to said simple sequencing engine for receiving data corresponding to a sequencing informational model defined externally to said simple sequencing engine.

2. The system of claim 1, wherein said interface further comprises a configuration for receiving sequencing context information for processing by said individual behavioral operations.

3. A pluggable simple sequencing engine comprising:
a plurality of behavioral operations implementing a sequencing behavioral model;
a mapping of said behavioral operations to navigation requests; and,
an interface both for receiving in said simple sequencing engine data implementing a sequencing informational model which has been defined externally to said simple sequencing engine, and also for returning to an external calling object sequencing information produced by processing said data in said behavioral operations.

4. The engine of claim 3, wherein said behavioral operations comprise at least one navigation operation selected from the group consisting of start, resume, continue, previous, choose and exit.

5. The engine of claim 3, wherein said interface further comprises a parameter conduit for receiving in said simple sequencing engine data application specific sequencing context which has been defined externally to said simple sequencing engine.

6. The engine of claim 5, wherein said specific sequencing context comprises at least one of an activity, attempt, global state, limit conditions, objective, progress and rollup context.

7. In a simple sequencing engine, a simple sequencing method comprising the steps of:
receiving in the engine a navigation request comprising a desired behavioral operation and data implementing an informational model defined in a coupled content delivery application;
extracting said desired behavioral operation from said navigation request;
mapping said desired behavioral operation to a method call in the engine;
passing said data to said method call for processing; and,
returning a result produced by said method call to said coupled content delivery application.

8. The method of claim 7, further comprising the steps of:
receiving sequencing context in association with said navigation request; and,
passing said sequencing context to said method call along with said data for consumption by said method call.

9. A method for configuring multiple content distribution applications for use with a singly programmed simple sequencing engine, the method comprising the steps of:
implementing a sequencing informational model in a content distribution application, while implementing a corresponding sequencing behavioral model in a singly programmed simple sequencing engine;
varying said sequencing informational model through multiple implementations of said sequencing informational model in the multiple content distribution applications; and,
pluggably coupling instances of said singly programmed simple sequencing engine to each of the multiple content distribution applications.

10. A machine readable storage having stored thereon a computer program for simple sequencing, the computer program comprising a routine set of instructions which when executed by the machine cause the machine to perform the steps of:
receiving in the engine a navigation request comprising a desired behavioral operation and data implementing an informational model defined in a coupled content delivery application;
extracting said desired behavioral operation from said navigation request;
mapping said desired behavioral operation to a method call in the engine;
passing said data to said method call for processing; and,
returning a result produced by said method call to said coupled content delivery application.

11. The machine readable storage of claim 10, further comprising the steps of:
receiving sequencing context in association with said navigation request; and,
passing said sequencing context to said method call along with said data for consumption by said method call.
